(19) United States
(12) Patent Application Publication
(10) Pub. No.: US 2026/0006581 A1
(43) Pub. Date: Jan. 1, 2026

(54) DOWNLINK CONTROL INFORMATION FOR MULTIPLEXED PAGING OCCASIONS

(71) Applicant: Lenovo (Singapore) Pte Ltd, Singapore (SG)

(72) Inventors: Karthikeyan Ganesan, Kronberg Im Taunus (DE); Ravi Kuchibhotla, Chicago, IL (US); Abdul Rasheed Mohammed, Hyderabad (IN)

(73) Assignee: Lenovo (Singapore) Pte Ltd, Singapore (SG)

(21) Appl. No.: 18/759,772

(22) Filed: Jun. 28, 2024

(51) Int. Cl. H04W 68/02; H04W 68/00

(52) U.S. Cl. CPC H04W 68/02; H04W 68/005

(57) ABSTRACT

Various aspects of the present disclosure relate to downlink control information (DCI) for multiplexed paging occasions. An apparatus, such as a UE, receives a message for configuring a DCI and corresponding set of DCI. In some cases, each of the DCI and the et of DCI are associated with a paging message. The UE receives the DCI based on a first time-frequency resource. The DCI includes one or more parameters that indicate a set of second time-frequency resources associated with the set of DCI. The set of DCI is at least one of frequency division multiplexed (FDMed) or time division multiplexed (TDMed) in respective paging occasions (POs) associated with the paging message. The UE monitors for the set of DCI based on the set of second time-frequency resources. For example, a base station transmits the set of DCI based on the second time-frequency resources.

### TECHNICAL FIELD

The present disclosure relates to wireless communications, and more specifically to resource management for wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include a UE for wireless communication to receive a message for configuring a downlink control information (DCI) and a set of DCI, where each of the DCI and the set of DCI are associated with a paging message, receive, based on a first time-frequency resource, the DCI including one or more parameters that indicate a set of second time-frequency resources associated with the set of DCI, where the set of DCI is at least one of frequency division multiplexed (FDMed) or time division multiplexed (TDMed) in respective POs associated with the paging message, and monitor for the set of DCI based on the set of second time-frequency resources.

In some implementations of the method and apparatuses described herein, the DCI includes at least one parameter, and to monitor for the set of DCI, the UE monitors for the set of DCI based on the at least one parameter, or refrains from monitoring for the set of DCI based on the at least one parameter. Additionally, or alternatively, the DCI includes at least one parameter that indicates the respective POs relative to a monitoring occasion associated with the DCI, and the first time-frequency resource includes the monitoring occasion. Additionally, or alternatively, the UE determines a subgroup of UEs based on a slot including the respective POs. Additionally, or alternatively, the UE determines a subgroup of UEs based on the respective POs being associated with at least one of consecutive time resources or consecutive frequency resources.

Additionally, or alternatively, the DCI includes a bitmap with a set of codepoints corresponding to the set of DCI, the set of codepoints indicating respective subgroups of UEs, and to monitor for the set of DCI, the UE monitors for the set of DCI based on a codepoint of the set of codepoints indicating a subgroup of UEs, or refrains from monitoring for the set of DCI based on a codepoint of the set of codepoints indicating a first subgroup of UEs different from a second subgroup of UEs. Additionally, or alternatively, the one or more parameters include a bitmap that indicates a resource in a frequency domain corresponding to at least one DCI of the set of DCI, and the set of second time-frequency resources includes the resource. Additionally, or alternatively, the one or more parameters indicate one or more of an offset in a time domain between the first time-frequency resource and at least one time-frequency resource of the set of second time-frequency resources or at least one resource in a frequency domain corresponding to the respective POs. Additionally, or alternatively, the set of second time-frequency resources includes a set of downlink shared channel resources. Additionally, or alternatively, the set of DCI includes scheduling information corresponding to respective downlink shared channels associated with the paging message, and the scheduling information includes a short message indicator, a short message, a modulation and coding scheme (MCS), at least one resource in a frequency domain corresponding to the paging message, or at least one resource in a time domain corresponding to the paging message.

Additionally, or alternatively, the DCI is scrambled with a paging-radio network temporary identifier (P-RNTI) corresponding to the UE. Additionally, or alternatively, the set of DCI is FDMed, and where the set of second time-frequency resources includes a single resource in a time domain and respective resources in a frequency domain corresponding to the set of DCI, the respective resources in the frequency domain based on one or more of the respective POs associated with the set of DCI, a starting resource block (RB) index associated with the set of DCI, or a frequency domain offset corresponding to the set of DCI.

Some implementations of the method and apparatuses described herein may further include a processor for wireless communication to receive a message for configuring a DCI and a set of DCI, where each of the DCI and the set of DCI are associated with a paging message, receive, based on a first time-frequency resource, the DCI including one or more parameters that indicate a set of second time-frequency resources associated with the set of DCI, where the set of DCI is at least one of FDMed or TDMed in respective POs associated with the paging message, and monitor for the set of DCI based on the set of second time-frequency resources.

Some implementations of the method and apparatuses described herein may further include a method performed by a UE, the method including receiving a message for configuring a DCI and a set of DCI, where each of the DCI and the set of DCI are associated with a paging message, receiving, based on a first time-frequency resource, the DCI including one or more parameters that indicate a set of second time-frequency resources associated with the set of DCI, where the set of DCI is at least one of FDMed or TDMed in respective POs associated with the paging message, and monitoring for the set of DCI based on the set of second time-frequency resources.

Some implementations of the method and apparatuses described herein may further include a base station for wireless communication to transmit a message for configuring a DCI and a set of DCI, where each of the DCI and the set of DCI are associated with a paging message, transmit, based on a first time-frequency resource, the DCI including one or more parameters that indicate a set of second time-frequency resources associated with the set of DCI, where the set of DCI is at least one of FDMed or TDMed in respective POs associated with the paging message, and transmit the set of DCI based on the set of second time-frequency resources.

In some implementations of the method and apparatuses described herein, the DCI includes at least one parameter that indicates for a UE to monitor for the set of DCI or to refrain from monitoring for the set of DCI. Additionally, or alternatively, the DCI includes at least one parameter that indicates the respective POs relative to a monitoring occasion associated with the DCI, and where the first time-frequency resource includes the monitoring occasion. Additionally, or alternatively, a subgroup of UEs associated with the paging message is based on a slot including the respective POs. Additionally, or alternatively, a subgroup of UEs associated with the paging message is based on the respective POs being associated with at least one of consecutive time resources or consecutive frequency resources. Additionally, or alternatively, the DCI includes a bitmap with a set of codepoints corresponding to the set of DCI, the set of codepoints indicating respective subgroups of UEs.

Additionally, or alternatively, the one or more parameters include a bitmap that indicates a resource in a frequency domain corresponding to at least one DCI of the set of DCI, and the set of second time-frequency resources includes the resource. Additionally, or alternatively, the one or more parameters indicate one or more of an offset in a time domain between the first time-frequency resource and at least one time-frequency resource of the set of second time-frequency resources or at least one resource in a frequency domain corresponding to the respective POs. Additionally, or alternatively, the set of second time-frequency resources includes a set of downlink shared channel resources. Additionally, or alternatively, the set of DCI includes scheduling information corresponding to respective downlink shared channels associated with the paging message, and the scheduling information includes a short message indicator, a short message, an MCS, at least one resource in a frequency domain corresponding to the paging message, or at least one resource in a time domain corresponding to the paging message.

Additionally, or alternatively, the DCI is scrambled with a P-RNTI corresponding to one or more UE. Additionally, or alternatively, the set of DCI is FDMed, and where the set of second time-frequency resources includes a single resource in a time domain and respective resources in a frequency domain corresponding to the set of DCI, the respective resources in the frequency domain based on one or more of the respective POs associated with the set of DCI, a starting RB index associated with the set of DCI, or a frequency domain offset corresponding to the set of DCI.

### BRIEF DESCRIPTION OF THE DRAWINGS

FIG. 1 illustrates an example of a wireless communications system in accordance with aspects of the present disclosure.

FIG. 2 illustrates an example of a transmission diagram, in accordance with aspects of the present disclosure.

FIGS. 3 and 4 illustrate examples of wireless communications systems in accordance with aspects of the present disclosure.

FIG. 5 illustrates an example of a transmission diagram, in accordance with aspects of the present disclosure.

FIG. 6 illustrates an example of a signaling diagram, in accordance with aspects of the present disclosure.

FIG. 7 illustrates an example of a UE in accordance with aspects of the present disclosure.

FIG. 8 illustrates an example of a processor in accordance with aspects of the present disclosure.

FIG. 9 illustrates an example of a network equipment (NE) in accordance with aspects of the present disclosure.

FIG. 10 illustrates a flowchart of a method performed by a UE in accordance with aspects of the present disclosure.

FIG. 11 illustrates a flowchart of a method performed by a NE in accordance with aspects of the present disclosure.

### DETAILED DESCRIPTION

Devices in a wireless communications system can implement one or more energy saving techniques. In some examples, a UE and/or a base station (e.g., a NE) in the wireless communications system can operate in one or more different modes that result in different power consumption by the UE and/or the base station including, but not limited to, an inactive or idle mode and an active mode. In the inactive mode or the idle mode, the UE and/or the base station can refrain from actively communicating (e.g., transmitting and receiving) signaling, leading to power savings as the components that perform the communicating can be powered down and/or enter a reduced power consumption state. In the active mode, the UE and/or the base station can communicate signaling, leading to a relatively high power consumption when compared with the power saving mode due to the components that perform the communicating being in an active state to transmit, receive, decode, and/or otherwise process the signaling. A base station in an inactive mode or an idle mode may periodically enter an active mode to transmit paging messages to one or more UEs. A paging message can notify the UE of an incoming transmission. However, the time resources that the base station uses to transmit the paging messages, referred to as POs and PFs, are distributed evenly across the time domain. Thus, the base station frequently enters the active mode to transmit paging messages during the time resources, which leads to increased power consumption at the base station.

As described herein, to reduce power consumption at a base station related to transmitting paging messages, a base station can transmit paging messages in paging occasions that are FDMed and/or TDMed. The base station can implement FDM techniques by transmitting multiple signals concurrently using same or overlapping resources in a time domain and different resources in a frequency domain. The base station can implement TDM techniques by transmitting multiple signals using same or overlapping resources in the frequency domain and different resources in the time domain. The base station can configure one or more UEs with multiple DCI messages that indicate resources of the paging occasions in the time domain and the frequency domain. For example, a first DCI message can indicate time-frequency resources used to transmit one or more second DCI messages that are FDMed and/or TDMed in respective paging occasions. The first DCI message can indicate for a subgroup of UEs to monitor for the second DCI messages. The second DCI messages can include scheduling information for receiving and decoding a paging message in a respective paging occasion.

Reference is made herein to communicating data or information, such as messages that configure control information and/or communication resources and messages that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

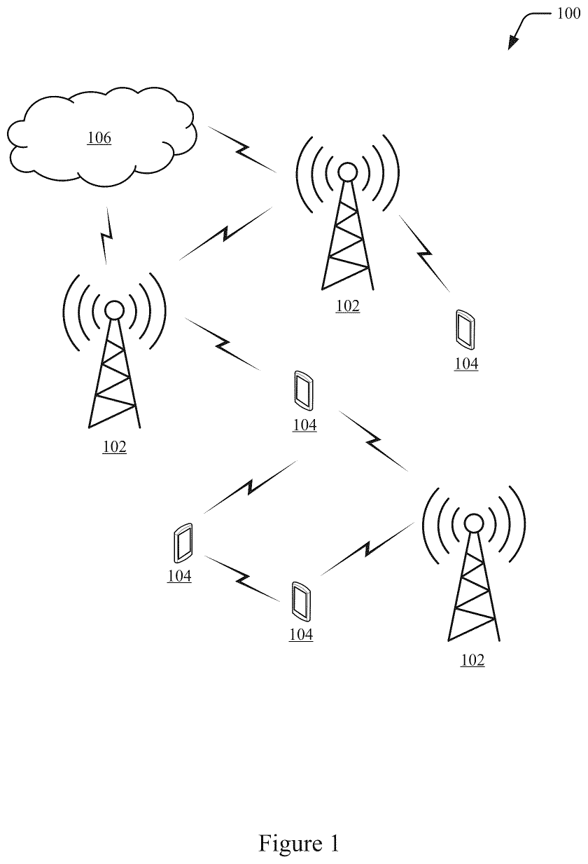

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a NE 102 (e.g., a base station) communicates a message to one or more UEs 104 that configures multiple DCI messages in a multi-stage DCI transmission scheme that include a first DCI message and multiple second DCI messages. The NE 102 can transmit a first DCI message (e.g., DCI) to one or more UEs, where the DCI message can indicate a subgroup of UEs for which the DCI message is intended for. The UEs can receive and decode the first DCI message. The first DCI message can indicate one or more resources in the time domain and the frequency domain for second DCI messages. The second DCI messages can be within resources of respective POs. The UEs in the subgroup of UEs can monitor for the second DCI messages, while the UEs that are not in the subgroup of UEs can refrain from monitoring for the second DCI messages. The second DCI messages can indicate information that the UEs can use to receive and decode respective paging messages within the POs.

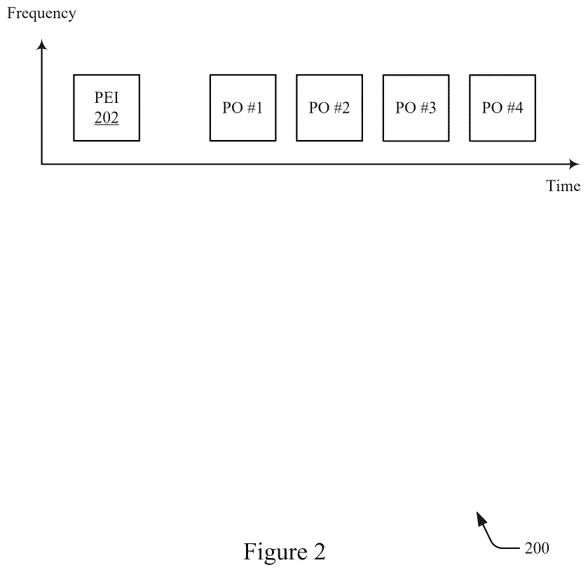

FIG. 2 illustrates an example of a transmission diagram 200 in accordance with aspects of the present disclosure. In some examples, the transmission diagram 200 implements or is implemented by aspects of the wireless communications system 100. For example, the transmission diagram 200 can be implemented by a UE and a NE, which may be examples of a UE 104 and a NE 102 as described with reference to FIG. 1. The NE and/or the UE can operate in one or more modes, including an active mode and an inactive mode, to reduce power consumptions of the NE and/or the UE.

In some examples, a NE and a UE can transmit and receive signaling, such as control signaling and/or data. The NE and the UE can transmit and receive the signaling via one or more communication links. For example, the NE can transmit signaling to the UE via a downlink communication link, while the UE can transmit signaling to the NE via an uplink communication link. The signaling can occupy one or more time-frequency resources, which can also be referred to as communication resources or resources. For example, the NE and/or the UE can transmit signaling using one or more radio frames. A radio frame is a unit of time used in wireless communication systems that represents a fixed duration of time during which data is transmitted over the air interface between the NE and the UE. A radio frame can be further divided into smaller units of time, such as slots or occasions. The NE and/or the UE can transmit the signaling using one or more frequency resources, including, but not limited to, frequency bands, component carriers (CCs), bandwidth parts (BWPs), among other example frequency resources.

In some examples, a NE and/or a UE can operate according to one or more modes or operation states. For example, the NE and/or the UE can implement discontinuous transmission (DTX) and discontinuous reception (DRX) techniques to reduce a power consumption at the NE and/or the UE. DTX is a technique used to conserve power by temporarily suspending the transmission of data from a UE to a NE during a time period, referred to as an inactive period or idle period. During the inactive period or the idle period, the UE and/or the NE can enter a sleep mode, an idle mode, or an inactive mode, in which the UE and/or the NE reduces or suspends entirely transmission of signaling. During one or more active periods, the UE and/or the NE can enter an active mode to transmit signaling. By avoiding transmission during idle periods, DTX reduces power consumption at the UE and/or the NE, extending battery life and conserving energy. Additionally, or alternatively, DRX is a technique used to conserve power by allowing a receiver of the UE and/or the NE to enter a sleep mode or other low-power state during time periods when the UE and/or the NE is not expecting incoming data (e.g., inactive periods). By avoiding reception during inactive periods, DRX reduces power consumption at the UE and/or the NE, extending battery life and conserving energy.

In some examples, reducing power consumption at the UE and/or the NE can reduce emissions by the UE and/or the NE, as well as reduce an operating expense related to implementing UEs and NEs with a continued rise in mobile data traffic (e.g., 6.4 gigabytes (GB) per user per month). In some cases, 5G NR improved energy-efficiency per GB over previous generations of mobility. However, new 5G use cases and the adoption of millimeter Wave (mm-Wave) communications may cause an increase in NEs to serve UEs over a geographic coverage area, leading to higher emissions.

Network energy saving can lead to environmental sustainability by reducing environmental impact (e.g., greenhouse gas emissions) and can reduce operational cost. As 5G is becoming pervasive across industries and geographical areas, handling more advanced services and applications that use relatively high data rates (e.g., greater than a threshold data rate, including extended reality (XR) related data), networks are becoming denser, use more antennas, have an increase in bandwidths, and more frequency bands. In some examples, the energy cost on a mobile network accounts for a relatively large amount of (e.g., 23%) of a total operator cost. The NEs and other devices in a RAN account for a relatively large amount (e.g., most) of the energy consumption, such as from an active antenna unit (AAU), with data centers and fiber transport accounting for a relatively small share. The power consumption of a RAN can be split into two components, including a dynamic power consumption component, where power is consumed when data transmission and/or reception is ongoing, and a static power consumption component, where power is constantly consumed to maintain the operation of the devices in the RAN (e.g., even when the data transmission and/or reception is not on-going).

A NE expends substantial energy (e.g., greater than a threshold power consumption) to transmit signaling, including, but not limited to, synchronization signal blocks (SSBs), physical broadcast channels (PBCHs) that include a master information block (MIB), one or more system information blocks (SIBs), and/or other system information and paging messages. The NE can transmit SSBs and SIBs (e.g., a SIB type 1 (SIB1)) for cell identification, idle mode mobility, connected mode mobility, etc. For example, the NE can periodically broadcast one or more SSBs to UEs within a coverage area of the NE. The SSBs include information for the UEs to perform time and frequency synchronization with the NE for reception of system information (e.g., the SIB1). A PBCH can include a MIB that indicates a system frame number (SFN), a subcarrier spacing, a bandwidth, among other information for reception of a SIB1. The SIB1 can indicate one or more time-frequency resources that include paging messages. The paging messages notify a UE in an inactive mode or idle mode of an incoming transmission (e.g., a data transmission). However, one or more of the UEs that the NE transmits the paging messages to may not be present within a coverage area of the NE. Thus, the energy consumption from the paging messages and related signaling can be unnecessary.

Additionally, or alternatively, conventional techniques for allocating time-frequency resources for transmission and reception of paging messages can include distributing allocated time resources evenly across a time domain for a given frequency resource in a frequency domain. The resources can include POs that define a time interval and/or frequency within a radio frame, referred to as a PF, during which a UE is to monitor for a paging message and/or during which a NE is to transmit a paging message. POs are scheduled by one or more parameters provided in the SIB1. Evenly distributing POs across a time domain hinders a RAN node (e.g., a NE) from entering inactive or idle modes for extended durations and/or from deactivating one or more components, as the NE may wake up periodically to send paging messages. The NE can transmit the paging messages even if the paged UEs are not in the coverage area of the NE, as the location of UEs in an inactive mode or idle mode is known at a registration area level (e.g., one or more tracking areas received in registration accept rather than by the NE).

In some examples, a UE may use DRX in an idle mode or an inactive mode (e.g., a radio resource control (RRC) idle state (RRC_IDLE) and/or an RRC inactive state (RRC_INACTIVE)) to reduce power consumption. In an RRC_IDLE state, the UE is not actively communicating with the NE. The UE periodically monitors for paging messages and can transition to an active state (e.g., RRC_CONNECTED) upon receiving a paging message. The UE conserves battery power in an RRC_IDLE state as no signaling connection is maintained with the NE. In an RRC_INACTIVE state the UE maintains a connection (e.g., an RRC connection) with the NE, which provides for a faster transition to an active state compared to the RRC_IDLE state. For example, the UE can receive a paging message and resume communications with a NE without reestablishing an RRC connection with the NE. In an RRC_CONNECTED state, the UE is actively communicating with the NE. In the RRC_INACTIVE and the RRC_IDLE states a NE can transmit control signaling to a UE that schedules one or more monitoring occasions, referred to as POs, during which the UE is to monitor for paging messages. The POs can fall within an active period of a DRX cycle of the UE.

For example, the UE monitors one PO per DRX cycle, where the PO includes a set of physical downlink control channel (PDCCH) monitoring occasions and can include multiple time slots (e.g., subframes or OFDM symbols) in which a paging DCI message can be sent. A PF is a radio frame that may contain one or more POs or is a starting point of a PO. In multi-beam operations, a same paging message and a same short message can be repeated in respective transmitted beams, and the UE can select a beam for reception of a paging message and a short message. A paging message can be the same for both RAN initiated paging and CN initiated paging.

The UE initiates an RRC connection resume procedure upon receiving RAN initiated paging. If the UE receives a CN initiated paging in an RRC_INACTIVE state, then the UE switches from the RRC_INACTIVE state to an RRC_IDLE and informs a non-access stratum (NAS) layer of the switch. In some cases, the NE (e.g., a RAN and/or a CN) can determine a PF and PO for paging according to Equation 1:

$$( SFN + {PF}_{offset} ) mod ( T ) = T ( divN ) * ( {UE}_{ID} mod ( N ) ) , \qquad ( 1 )$$

where the NE determines an index is of the PO according to Equation 2:

$${i}_{s} = floor ( \frac{{UE}_{ID}}{N} ) mod ( {N}_{s} ) . \qquad ( 1 )$$

The NE can determine a PDCCH monitoring occasion for paging according to one or more parameters, such as a pagingSearchSpace parameter, a firstPDCCH-MonitoringOccasionOfPO parameter, and a nrofPDCCH-MonitoringOccasionPerSSB-InPO parameter, which can be preconfigured or defined. If a SearchSpaceId parameter has a value of zero for pagingSearchSpace, then one or more PDCCH monitoring occasions for paging are the same as for remaining minimum system information (RMSI). If the SearchSpaceId parameter has a value of zero for pagingSearchSpace, then Nₛ can have a defined integer value (e.g., one or two). If Nₛ is one, then there is one PO that starts from a first PDCCH monitoring occasion for paging in a PF. If Nₛ is two, then there is a PO in either a first half frame (e.g., iₛ=0) or a second half frame (e.g., iₛ=1) of the PF. In some cases, if he SearchSpaceId parameter has a value other than zero for pagingSearchSpace, then the UE can monitor for a paging message in a PO with a defined index (e.g., iₛ+1).

A PO is a set of consecutive PDCCH monitoring occasions (e.g., S*X PDDCH monitoring occasions, where S is a number of actual transmitted SSBs determined according to a parameter ssb-PositionsInBurst in SIB1 and X is equal to a value of a parameter nrofPDCCH-MonitoringOccasionPerSSB-InPO if configured or is equal to 1 otherwise). In some examples, a (x*S+K)^{th} PDCCH monitoring occasion for paging in the PO corresponds to the K^{th} transmitted SSB, where x=0, 1, . . . , K−1, K=1, 2, . . . , S. The PDCCH monitoring occasions for paging that do not overlap with uplink symbols (e.g., determined according to a defined configuration, tdd-UL-DL-ConfigurationCommon) are sequentially numbered from zero starting from the first PDCCH monitoring occasion for paging in the PF. When a parameter, firstPDCCH-MonitoringOccasionOfPO, is present, the starting PDCCH monitoring occasion number of (iₛ+1)^{th} PO is the (iₛ+1)^{th} value of the firstPDCCH-MonitoringOccasionOfPO parameter. If the parameter is not present, then the starting PDCCH monitoring occasion number is equal to iₛ*S* X. If X>1, when the UE detects a PDCCH transmission addressed to a P-RNTI within a PO, then the UE does not monitor the subsequent PDCCH monitoring occasions for the PO.

In some cases, a PO associated with a PF may start in the PF or after the PF. Additionally, or alternatively PDCCH monitoring occasions for a PO can span multiple radio frames. When a value of the SearchSpaceId parameter is other than zero for a paging-SearchSpace, the PDCCH monitoring occasions for a PO can span multiple periods of the paging search space. In some examples, the NE can use one or more parameters to calculate the PF and iₛ for transmitting a paging message to a UE. The parameters can include a DRX cycle of the UE, T. If the UE does not operate in extended DRX (eDRX), which has a longer inactive duration or OFF duration when compared with DRX, then T is determined by a shortest of the UE specific DRX values (e.g., if configured by RRC and/or upper layers or provided in sidelink (PC5)-RRC signaling in case of a L2 UE to network (U2N) relay UE) and a default DRX value broadcast in system information. In an RRC_IDLE state, if a UE specific DRX is not configured by upper layers, then a default value is applied. In the RRC_IDLE state, if the UE operates in eDRX and eDRX is configured by upper layers (e.g., time eDRX (TeDRX), CN), and if TeDRX, CN is no longer than a threshold numerical quantity of radio frames (e.g., 1024 radio frames), then T=TeDRX, CN. If TeDRX, CN is longer than the threshold numerical quantity of radio frames the CN determines the value of T when configuring a paging time window (PTW) by determining a shortest UE specific DRX value, if configured by upper layers, and the default DRX value broadcast in system information.

In an RRC_INACTIVE state, if the UE operates in eDRX and eDRX is configured by RRC (e.g., TeDRX, RAN) and/or upper layers (e.g., TeDRX, CN), and if both TeDRX, CN and used TeDRX, RAN are no longer than a threshold numerical quantity of radio frames (e.g., 1024 radio frames), then T=min {TeDRX, RAN, TeDRX, CN}. If TeDRX, CN is no longer than the threshold numerical quantity of radio frames and TeDRX, RAN is not configured or used, then T is determined by the shortest of UE specific DRX value configured by RRC and TeDRX, CN. If TeDRX, CN is longer than the threshold numerical quantity of radio frames, and if TeDRX, RAN is not configured or used, then during CN configured PTW, T is determined by the shortest of the UE specific DRX values, if configured by RRC and/or upper layers, and a default DRX value broadcast in system information. Outside the CN configured PTW, a NE can determine T using the UE specific DRX value configured by RRC. In some cases, if TeDRX, RAN is used and is no longer than the threshold numerical quantity of radio frames, during CN configured PTW, T is determined by the shortest of the UE specific DRX value, if configured by upper layers and TeDRX, RAN, and a default DRX value broadcast in system information. Outside the CN configured PTW, T is determined by TeDRX, RAN.

In some cases, N is a number of total paging frames in T, Nₛ is a number of paging occasions for a PF, PF_{offset} is an offset used for PF determination, and the UE_{ID} depends on whether the UE operates in eDRX or not. If the UE operates in eDRX, then the UE_{ID} is a defined value (e.g., 5G system temporary mobile subscriber identity (5G-S-TMSI) mod 4096). If the UE does not operate in eDRX, then the UE_{ID} is a different defined value (e.g., 5G-S-TMSI mod 1024). The values of the parameters Nₛ, nAndPagingFrame Offset, nrofPDCCH-MonitoringOccasionPerSSB-InPO, and a length of a default DRX cycle are signaled in SIB1. The values of N and PFoffset are derived from the parameter nAndPagingFrameOffset. The parameter firstPDCCH-MonitoringOccasionOfPO is signalled in SIB1 for paging in the BWP configured by initialDownlinkBWP. For paging in a downlink BWP other than the BWP configured by initialDownlinkBWP, the parameter first-PDCCH-MonitoringOccasionOfPO is signaled in the corresponding BWP configuration. If there is no defined value for the UE_{ID} (e.g., if the UE has no 5G-S-TMSI), such as when the UE has not yet registered to a network, then the UE can use a default identity (e.g., UE_{ID}=0) in the PF and the iₛ in Equation 1 and Equation 2. In some cases, the UE_{ID} (e.g., 5G-S-TMSI) is a 48 bit long bit string and can be interpreted as a binary number where the left most bit represents the most significant bit.

In an RRC_INACTIVE state, if the UE supports inactiveStatePO-Determination and the network broadcasts ranPagingInIdlePO with a value of “true,” then the UE can use a same is as for an RRC_IDLE state. Otherwise, the UE determines the value of iₛ using the parameters and Equations described herein. In an RRC_INACTIVE state, if an eDRX value configured by upper layers and used by the UE is no longer than a threshold numerical quantity of radio frames (e.g., 1024 radio frames), then the UE can use a same iₛ as for RRC_IDLE state. In an RRC_INACTIVE state, an eDRX value configured by upper layers and used by the UE is longer than the threshold numerical quantity of radio frames, then during CN PTW, the UE can use a same iₛ as for the RRC_IDLE state. Outside CN PTW, the UE can use the iₛ for the RRC_INACTIVE state.

In some examples, a frequency of PFs can be decreased by extending the values of N to have increased interval between PFs (T/64, T/128, etc.) and compensating the decrease in the number of PFs by increasing POs per PF. However, the NE may transmit a same numerical quantity of transmissions since a total number of POs remains the same, leading to a same energy consumed by the NE. In some cases, conventional techniques for paging include transmission of an early paging indicator (PEI) 202 that indicates one or more POs (e.g., the PO #1 through the PO #4) that include paging messages. For example, the PEI 202 provides for a subgroup of UEs to wake up and monitor for paging messages during at least one PO (e.g., the PO #1, the PO #2, the PO #3, and/or the PO #4). The NE can transmit the PEI 202 to the UE in a DCI message (e.g., DCI format 2_7). The PEI 202 can include codepoints for respective subgroups of UEs. A PO can include paging monitoring occasion (e.g., DCI 1_0 monitoring occasions).

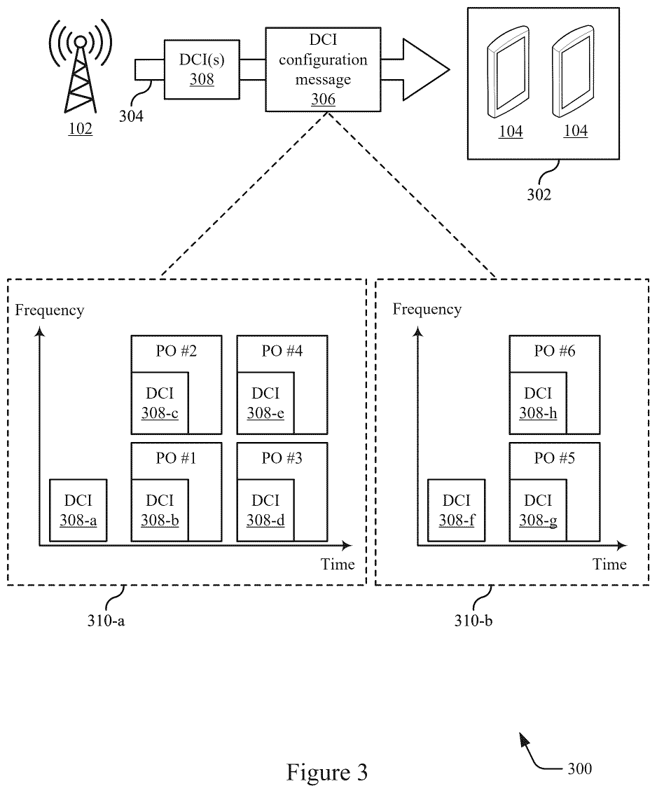

In some examples, to reduce power consumption at a NE due to transmitting paging messages, a NE can use FDM and TDM transmission techniques to transmit paging messages. The NE can configure multiple DCI messages to indicate one or more time-frequency resources used to transmit the paging messages. The DCI messages can include a first DCI that indicates respective time and frequency resources of DCI messages that provide information for receiving and decoding paging messages, which is described in further detail with respect to FIGS. 2 and 3.

FIG. 3 illustrates an example of a wireless communications system 300 in accordance with aspects of the present disclosure. In some examples, the wireless communications system 300 implements or is implemented by aspects of the wireless communications system 100 and the transmission diagram 200. For example, the wireless communications system 300 can include one or more UEs 104 and a NE 102, which may be examples of UEs 104 and a NE 102 as described with reference to FIG. 1. The NE 102 may be an example of a base station and/or a serving cell. In some examples, the NE 102 can transmit signaling, such as control signaling and/or data, to UEs within a coverage area of the NE 102, which can include the UEs 104 and/or one or more additional UEs. The UEs within the coverage area of the NE 102 can be divided into one or more subgroups of UEs, such as the subgroup 302 that includes the UEs 104. Although the subgroup 302 is illustrated as including two UEs 104, the subgroup 302 can include any numerical quantity of UEs.

The UEs 104 can receive one or more messages (e.g., signaling) from the NE 102 via a downlink communication link 304, while the UE can transmit signaling to the NE via an uplink communication link. For example, the NE 102 can transmit control signaling to the UE 104 via the downlink communication link 304, such as a DCI configuration message 306 that configures DCI 308 (e.g., DCI messages). The NE 102 can transmit the DCI configuration message 306 to the UEs 104 in periodic and/or semi-static control signaling, such as via RRC signaling or a MAC-CE. The DCI configuration message 306 can configure the UEs 104 with a first DCI message that indicates multiple second DCI messages in a multi-stage DCI transmission scheme for paging.

In some cases, the NE 102 and/or the UEs 104 can operate in one or more modes (e.g., states), including an active mode, an inactive mode, or an idle mode, to reduce power consumptions of the NE 102 and/or the UEs 104. The NE 102 can transition from an inactive mode to an active mode to transmit the DCI configuration message 306, the DCIs 308, and/or paging messages to the UEs 104. The UEs 104 can monitor for the DCIs during an active period of a DRX cycle in an inactive mode and/or an idle mode (e.g., during scheduled time-frequency resources). In some examples, to reduce a duration the NE 102 and/or the UEs 104 spend monitoring for paging messages in an inactive mode and/or the idle mode and a corresponding power consumption of the NE 102 and/or the UEs 104 in the inactive mode and/or the idle mode, the NE 102 can FDM and/or TDM one or more POs in a PF.

In some cases, such as for a DCI configuration 310-a, the PO #1 and the PO #2, as well as the PO #3 and the PO #4, respectively, can be FDMed. For example, the PO #1 and the PO #2 share overlapping resources in the time domain and are allocated different resources in the frequency domain. Similarly, the PO #3 and the PO #4 share overlapping resources in the time domain and are allocated different resources in the frequency domain. The PO #1 and the PO #3 are TDMed, such that the PO #1 and the PO #3 share overlapping resources in the frequency domain and are allocated different resources in the time domain. The PO #2 and the PO #4 are also TDMed, such that the PO #2 and the PO #4 share overlapping resources in the frequency domain and are allocated different resources in the time domain. Thus, the PO #1, the PO #2, the PO #3, and the PO #4 are TDMed and FDMed. In some other cases, such as for a DCI configuration 310-b, the PO #5 and the PO #6 are FDMed, such that the PO #5 and the PO #6 share overlapping resources in the time domain and are allocated different resources in the frequency domain. The PO #5 and the PO #6 are not TDMed with other POs.

In some examples, a numerical quantity of POs FDMed in a slot allocated for paging can be semi-statically configurable (e.g., via RRC signaling and/or via a MAC-CE). For example, the DCI configuration message 306 can include one or more parameters that indicate the numerical quantity of POs FDMed in a slot allocated for paging information. Although the DCI configuration 310-a and the DCI configuration 310-b illustrate two POs sharing a resource in the time domain (e.g., two FDMed POs), the numerical quantity of POs that share a resource in the time domain can be any numerical quantity of POs. By using FDM techniques and/or TDM techniques to transmit paging messages in POs that share a same resource in the time domain and/or are consecutive in the time domain, respectively, a NE 102 can deliver the paging messages over a shorter duration when compared with POs that are distributed across the time domain, as described with reference to FIG. 2. Thus, the NE 102 can transmit the paging messages over the shorter duration, and then can enter an inactive mode or idle mode, which leads to reduced power consumption at the NE 102. The NE 102 can transmit one or more messages including DCI 308 to the UEs 104 to indicate a location in the time domain and the frequency domain of the POs.

Respective POs that are FDMed and/or TDMed can have separate monitoring occasions for DCI 308 scrambled with P-RNTIs, and the DCI 308 can be transmitted in a PDCCH search space dedicated for paging, a common search space, or any combination thereof belonging to a common CORESET, paging dedicated CORESET, CORESET 0, among others. However, scrambling a DCI 308 for each PO with a P-RNTI can lead to increased processing and latency at the UEs 104 due to increased blind decoding at the UEs 104. For example, a UE 104 in the subgroup 302 can receive DCI 308 for each PO scheduled by the NE 102 regardless of whether the DCI 308 is intended for the subgroup 302. The UE 104 can perform blind decoding to determine whether the DCI 308 is intended for the subgroup 302. Blind decoding is a process in which the UE 104 attempts to decode the DCI 308 without prior knowledge of transmission parameters of the DCI 308, such as a modulation and coding scheme (MCS), coding rate, or the position of the transmission in the time domain and the frequency domain. If the UE 104 attempts to decode the DCI 308 and the DCI 308 is not intended for the subgroup 302 (e.g., scrambled with a P-RNTI that identifies a different subgroup from the subgroup 302), then the UE 104 does not monitor for (e.g., refrains from monitoring for) paging messages in the PO indicated by the DCI 308. If the DCI 308 is intended for the subgroup 302 (e.g., scrambled with a P-RNTI that identifies the subgroup 302), then the UE 104 decodes the DCI 308 and monitors for paging messages in the PO indicated by the DCI 308. The UEs 104 in the subgroup 302 blind decoding the DCI 308 in respective monitoring occasions for the POs can increase the processing and latency due to the POs sharing time resources.

In some examples, to reduce processing and latency related to blind decoding DCI 308 in respective monitoring occasions for the POs, the NE 102 can configure a multi-stage DCI transmission scheme (e.g., with two or more different types of messages including DCI) to indicate the POs that are FDMed and/or TDMed. For example, the NE 102 can transmit the DCI configuration message 306 that indicates for the UE to monitor for a first DCI 308 that is scrambled with a P-RNTI, where the first DCI 308 indicates at least one second DCI 308 located within respective POs. The NE 102 transmits the first DCI 308 in a PDCCH search space and the second DCI 308 as part of (e.g., within) a physical downlink shared channel (PDSCH) resource of each FDMed PO. Each second DCI 308 can be transmitted together with the PDSCH and within each of the FDMed POs and/or PDSCH in a slot. Each of the second DCI 308 can include scheduling information, such as a MCS, that the UEs 104 can use to decode the corresponding PDSCH including a paging message. Additionally, or alternatively, the second DCI 308 can include a short messaging payload for the UEs 104. The first DCI 308, which is included in a PDCCH, may be transmitted in a paging search space, a common search space of a common CORESET, a dedicated CORESET for paging, a CORESET 0, or any combination thereof.

In some variations, the NE 102 can configure a new monitoring occasion mapping scheme between a first DCI 308 and one or more second DCI 308 in a PO, such that the one or more FDMed POs in a slot of a PF and/or TDMed POs in multiple slots can be represented by a number of POs per first DCI 308. The number of POs per first DCI 308 can be configured by a higher layer parameter (e.g., in RRC signaling and/or a MAC-CE). The first DCI can indicate the monitoring occasions for second DCI 308. In some other variations, the NE 102 can configure a mapping between multiple monitoring occasions for first DCI 308 to one or more groups of FDMed POs or groups of second DCI 308. The mapping can be represented by a number of POs per first DCI 308 and can be configured by a higher layer parameter. The monitoring occasions for the first DCI 308 can be in a same or different search space, CORESETs, time slots, FDMed in same time slot, or any combination thereof.

In some examples, the first DCI 308 can include subgrouping information that indicates a subgroup 302 of UEs 104 that are to wake up to monitor for a paging message. The subgrouping information can indicate for the UEs 104 in the subgroup 302 to monitor for the paging message using one or more FDMed and/or TDMed POs that are mapped to the monitoring occasion of the first DCI 308. For example, the DCI configuration 310-b can indicate that the PO #5 and the PO #6 belong to the subgroup 302. In some other cases, one or more FDMed and/or TDMed POs transmitted consecutively in the time domain (e.g., a burst of POs) can belong to a same subgroup of UEs 104 (e.g., the subgroup 302). For example, the DCI configuration 310-a can indicate that the PO #1 through the PO #4 belong to the subgroup 302.

The first DCI 308 can include subgrouping information to wake up UEs 104 belonging to a same subgroup (e.g., the subgroup 302) to monitor for paging messages in one or more FDMed and/or TDMed POs associated with the DCI 308. In some cases, the first DCI 308 and/or other control information (e.g., the DCI configuration message 306, other semi-static control signaling, or system information) can indicate an offset in the time domain, where the offset is between a monitoring occasion of the first DCI 308 and the second DCI 308. For example, the offset can include a slot offset or a symbol offset in terms of a numerical quantity (e.g., number, amount) of slots or symbols configured between the monitoring occasion of the first DCI 308 and monitoring occasions of the second DCI 308 that are FDMed and belong to a same subgroup 302. The offset can ensure the UEs 104 do not buffer the paging messages (e.g., paging data) before determining whether the UEs 104 are paged or not. In some cases, the UEs 104 can determine whether to monitor for the second DCI 308 and corresponding PDSCH including the paging message or not. For example, the UEs 104 can monitor for the second DCI 308 if a codepoint in the first DCI 308 is enabled for the subgroup 302. In some other examples, the UEs 104 can refrain from monitoring for the second DCI 308 (e.g., not monitor for the second DCI 308) if a codepoint in the first DCI 308 is disabled for the subgroup 302. The first DCI 308 can include a bitmap with respective codepoints that indicate a subgroup identity.

In some examples, if the POs are FDMed, then the first DCI 308 can include a parameter that indicates a time resource (e.g., a slot) of the FDMed POs. The parameter can include a time resource indicator value (TRIV), and the POs can share the time resources. The first DCI 308 can include one or more parameters that indicate respective frequency resources of the FDMed POs. The parameters can include a frequency resource indicator value (FRIV) that indicates a starting RB index (e.g., a lowest RB starting position) of the second DCI 308. The FRIV can encode a frequency domain offset of the second DCI 308, where the offset granularity for the FRIV indication can be configured in terms of RBs or RB groups (RBGs) including N physical RBs (PRBs) or a subchannel including N PRBs. In some cases, the UEs 104 can estimate an offset of one or more second DCI 308 using a frequency domain location of an initial second DCI 308.

In some cases, the NE 102 can bundle consecutive PRBs within a BWP and can indicate each RBG to the UEs 104 by providing a bitmap in the first DCI 308 that the frequency domain location of the second DCI 308. A size of the RBG can be semi-statically configured for paging and can vary according to the BWP size. For example, Table 1 includes an example of a bitmap that a UE 104 can use to determine a frequency domain location of a second DCI 308. A “1” bitmap value indicates that the RBG associated with that bitmap value is allocated for a data transmission, while a “0” bitmap value indicates that the RBG associated with that bitmap value is not allocated for a data transmission.

TABLE 1
Bitmap values indicating RBG indices allocated for a data transmission.

| PRB index | 0 | 1 | 2 | 3 | 4 | 5 | 6 | 7 | 8 | 9 | 10 | 11 | 12 | 13 | 14 | 15 | 16 | 17 | . . . | 48 | 49 |
|---|---|---|---|---|---|---|---|---|---|---|---|---|---|---|---|---|---|---|---|---|---|
| RBG index | RBG 0 | | | RBG 1 | | | RBG 2 | | | RBG 3 | | | RBG 4 | | | RBG 5 | | | . . . | RBG 16 | |
| Bitmap | 0 | | | 0 | | | 1 | | | 1 | | | 0 | | | 1 | | | | 0 | |
| value | | | | | | | | | | | | | | | | | | | | | |

In some examples, a size of the RBG (e.g., how many PRBs are included in the RBG) can depend on a system bandwidth,

$${N}_{RB}^{DL} .$$

For example, a system bandwidth of 10 can lead to 3 PRBs in an RBG, as shown in Table 1. The greater the system bandwidth, the greater the numerical quantity of PRBs in an RBG.

In some examples, the first DCI 308 can indicate a start RB and a number of consecutive RBs within a BWP. For example, the first DCI 308 can include a parameter, referred to as a resource indicator value (RIV), that indicates the starting RB and the number of consecutive RBs within a BWP. If

$$( {L}_{RBs} - 1 ) \leq ⌊ \frac{{N}_{BWP}^{size}}{2} ⌋ ,$$

then

$$RIV = {N}_{BWP}^{size} ( {L}_{RBs} - 1 ) + {RB}_{start} .$$

If within a BWP. If

$$( {L}_{RBs} - 1 ) > ⌊ \frac{{N}_{BWP}^{size}}{2} ⌋ ,$$

then

$$RIV = {N}_{BWP}^{size} ( {N}_{BWP}^{size} - {L}_{RBs} + 1 ) + ( {N}_{BWP}^{size} - 1 - {RB}_{start} ) .$$

The NE 102 can indicate a resource allocation for the UE 104 to use (e.g., using a bitmap and/or using a parameter in the first DCI 308) is semi-statically configured in a SIB as part of a paging configuration or dynamically signaled in the DCI as a resource allocation type.

In some examples, the first DCI 308 (e.g., the DCI 308-a and/or the DCI 308-f) can include one or more fields and can be transmitted using a format scrambled with a P-RNTI. In some cases, a number of POs per first DCI 308 is configured by a higher layer parameter in higher layer signaling, a number of subgroups assigned to a PO is configured by higher layer signaling, each bit in a field in the first DCI 308 indicates one UE subgroup of one or more POs, and a time domain offset field indicates a time domain offset between the first DCI 308 and the second DCI 308. In some examples, a frequency domain resource assignment of POs can be determined based on a number of bits,

$${log}_{2} ( \frac{{N}_{FDM}^{PO} * {N}_{FDM + 1}^{PO}}{2} ) ,$$

where the number of FDMed POs is two. If the number of FDMed POs is three, then the number of bits is

$${log}_{2} ( \frac{{N}_{FDM}^{PO} * {N}_{FDM + 1}^{PO}}{6} ) ,$$

where number of FDMed POs is represented by a higher layer parameter,

$${N}_{FDM}^{PO} .$$

In some examples, the second DCI 308 (e.g., the DCI 308-c through the DCI 308-d, as well as the DCI 308-h, and the DCI 308-g) can include one or more fields and can be carried on a PDSCH using rate matching. One or more bits of the PDSCH are mapped to one or more information bits a₀ to a_{A-1}. For example, each field of the second DCI 308 is mapped to the information bits, with the first field mapped to the lowest order information bit a₀ and each successive field mapped to higher order information bits. The most significant bit of each field is mapped to the lowest order information bit for that field (e.g., a most significant bit of the first field is mapped to a₀). The fields can include, but are not limited to, a short message indicator, a short message, a MCS, a frequency domain resource assignment, and a time domain resource assignment, among others.

The DCI 308-a in the DCI configuration 310-a can be an example of a first DCI 308. The DCI 308-a can indicate time resources and/or frequency resources of the DCI 308-b, the DCI 308-c, the DCI 308-d, and/or the DCI 308-e, where the DCI 308-b through the DCI 308-e can be examples of second DCI 308. The DCI 308-b can be located within a resource of a PO #1, the DCI 308-c can be located within a resource of a PO #2, the DCI 308-d can be located within a resource of a PO #3, and the DCI 308-e can be located within a resource of a PO #4. The DCI 308-f in the DCI configuration 310-b can be an example of a first DCI 308. The DCI 308-f can indicate a time resource and respective frequency resources of the DCI 308-g and the DCI 308-h, where the DCI 308-g and the DCI 308-h can be examples of second DCI 308. The DCI 308-g can be located within a resource of a PO #5 and the DCI 308-h can be located within a resource of a PO #6.

In some examples, the NE 102 can transmit control signaling (e.g., broadcast a SIB1) that indicates a search space, control resource set (CORESET), and/or one or more monitoring occasions of the first DCI 308 or a DCI 308 corresponding to the PEI monitoring occasions that falls within a DTX active duration of the NE 102. The UEs 104 may receive the control signaling as part of an initial access procedure. The UEs 104 can monitor for the first DCI 308 and/or the DCI 308 corresponding to the PEI to obtain information about respective subgroups of UEs (e.g., the subgroup 302 for the UEs 104) and corresponding POs. The DCI 308 can indicate time resources and/or frequency resources for one or more POs which may be FDMed and/or TDMed.

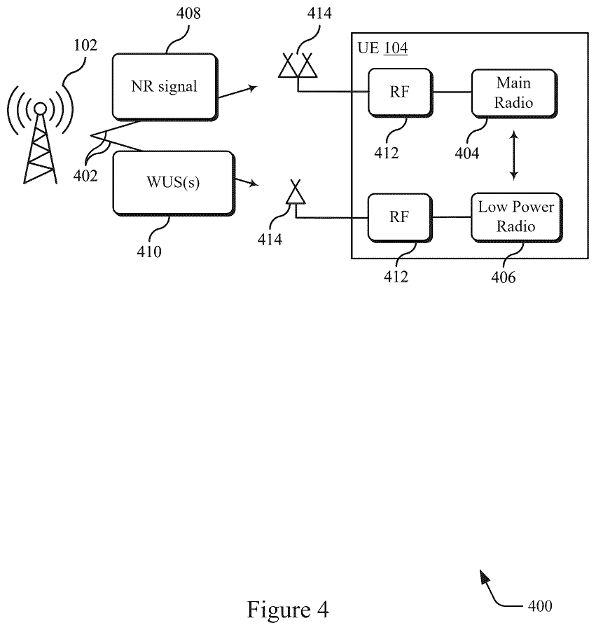

FIG. 4 illustrates an example of a wireless communications system 400 in accordance with aspects of the present disclosure. In some examples, the wireless communications system 400 implements or is implemented by aspects of the wireless communications system 100, the transmission diagram 200, and the wireless communications system 300. For example, the wireless communications system 400 can include a UE 104 and a NE 102, which may be examples of a UE 104 and a NE 102 as described with reference to FIGS. 1 and 3. The NE 102 may transmit signaling to one or more radios of the UE 104 via a downlink wireless communications links 402. For example, the NE 102 may transmit data, control signaling, or both to the UE 104 via the downlink wireless communications links 402. Although the downlink wireless communications links 402 are illustrated as separate wireless communications links, the NE 102 may establish a single downlink wireless communication link 402 with the UE 104.

In some cases, a UE 104 may include multiple radio components for transmitting and receiving signaling from a network device, such as the NE 102. The radio components may have different power consumption levels. For example, the UE 104 may include a main radio 404 with a relatively high power consumption level and a low power radio 406 with a relative low power consumption level. The relatively high power consumption level may be a power consumption level that exceeds a threshold value (e.g., a preconfigured value). The relatively low power consumption level may be a power consumption level that is less than a threshold value (e.g., a same threshold value used for the relatively high power consumption or a different threshold value). The main radio 404 may additionally, or alternatively, be referred to as or may implement a main receiver. Similarly, the low power radio 406 may additionally, or alternatively, be referred to as or may implement a low power receiver and/or a low power wake-up radio (LP-WUR). The main radio 404 may monitor for and receive NR signaling 408, which may use higher power relative to signaling sent to the low power radio 406. For example, the low power radio 406 may receive a WUS 410 to trigger activation of the main radio 404, referred to as a low power WUS (LP-WUS). The low power radio 406 may activate, or wake-up, the main radio 404 upon receiving a WUS 410 (e.g., by triggering or otherwise initiating an active mode at the low power radio 406).

The low power radio 406 may operate with reduced power consumption and/or reduced processing relative to the main radio 404. Thus, the low power radio 406 monitoring for a WUS 410 may use relatively fewer power resources and/or processing resource relative to a main radio 404 monitoring for the WUS 410, providing for reduced power consumption at the UE 104. A UE 104 may include any numerical quantity of radios (e.g., main radios 404 and low power radios 406). The low power radio 406 may operate at a lower power consumption level than a main radio 404 due to reduced monitoring capability (e.g., monitoring for less duration than the main radio 404, monitoring a smaller coverage area than the main radio 404, etc.), reduced processing capability, or the like. The main radio 404 may operate at a higher power consumption level than the low power radio 406 due to increasing a monitoring coverage area and/or processing different types of signaling, including signaling that takes additional power consumption to process (e.g., the NR signaling 408).

In some examples, a low power radio 406 may have a separate baseband (BB) processor, radio frequency (RF) chain 412, and/or antenna 414 than the main radio 404. In some other examples, the low power radio 406 may have a separate BB processor but a shared RF chain 412 and a shared antenna 414 with the main radio 404. In yet other examples, the low power radio 406 may have a shared BB processor, RF chain 412, and antenna 414 with the main radio 404.

In some examples, a NE 102 can implement a WUS 410 (e.g., a LP-WUS) in addition to, or as an alternative to, the first DCI, as described with reference to FIGS. 1 through 3. For example, the UE 104 can monitor for and receive a WUS 410 using a low power radio 406 and can wake up the main radio 404. The main radio 404 can monitor for a DCI messages and corresponding paging messages using PO information included in the WUS 410. The PO information can indicate one or more FDMed and/or TDMed POs. For example, the WUS 410 can include similar, or the same, information as the first DCI described with reference to FIG. 3, as well as a wake up indicator. The wake up indicator can be an example of a field (e.g., parameter) that indicates for the UE 104 to wake up the main radio 404.

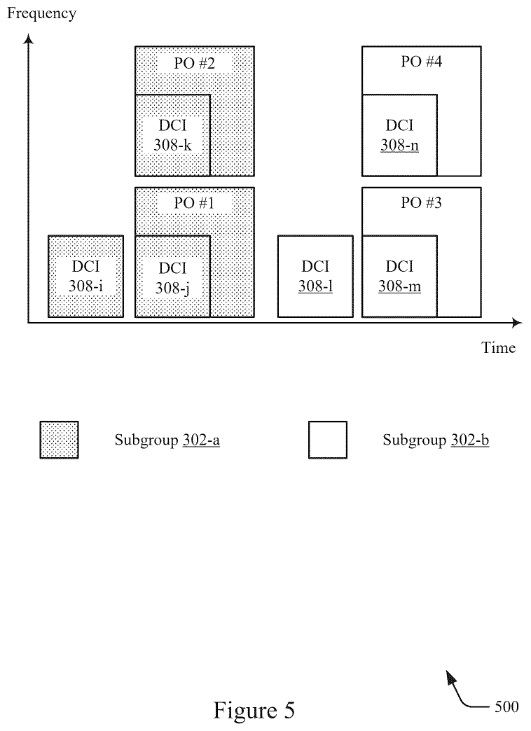

FIG. 5 illustrates an example of a transmission diagram 500 in accordance with aspects of the present disclosure. In some examples, the transmission diagram 500 implements or is implemented by aspects of the wireless communications system 100, the transmission diagram 200, and the wireless communications system 300. For example, the transmission diagram 500 can be implemented by one or more UEs and a NE, which may be examples of UEs 104 and a NE 102 as described with reference to FIG. 1. The NE can transmit a message to the UEs that configures the UEs with a multi-stage DCI transmission scheme, as described with reference to FIGS. 1 through 3.

For example, the NE can transmit a message to multiple UEs in different subgroups of UEs, including the subgroup 302-a and the subgroup 302-b. The subgroups of UEs (e.g., the subgroup 302-a and the subgroup 302-b) can include any numerical quantity of UEs. In some cases, the subgroup 302-a can include a same numerical quantity of UEs as the subgroup 302-b. In some other cases, the subgroup 302-a can include a different numerical quantity of UEs than the subgroup 302-b. Additionally, or alternatively, there can be any numerical quantity of subgroups of UEs. Subgroups of UEs for paging are defined using various criteria, such as using a geographic location of the UEs 104, DRX cycles of the UEs, one or more unique identifiers of the UEs, and/or a service type and priority of communications between the NE and the UEs, among other factors. Dividing the UEs within a coverage area of the NE into subgroups provides for the NE to manage resources efficiently, reduce UE power consumption, and ensure timely delivery of paging messages. The NE can define POs during which UEs in a respective subgroup are to monitor for paging messages.

In some cases, a first DCI in a multi-stage DCI transmission scheme can be scrambled with a P-RNTI that is unique to a subgroup of UEs. For example, the DCI 308-i can be scrambled with a P-RNTI unique to the subgroup 302-a and/or can otherwise indicate the subgroup 302-a. The DCI 308-i can indicate one or more time resources and/or frequency resources for the UEs within the subgroup 302-a to use to monitor for second DCI (e.g., DCI 308-j and DCI 308-k). The second DCI can be within POs allocated for paging messages to the subgroup 302-a, such as the PO #1 and the PO #2. Thus, the UEs within the subgroup 302-a can receive the DCI 308-i and can monitor for the DCI 308-j and the DCI 308-k. The UEs within the subgroup 302-a can receive the DCI 308-j and/or the DCI 308-k and can use scheduling information included in the DCI 308-j and/or the DCI 308-k to receive and decode one or more paging messages in the PO #1 and/or the PO #2.

The DCI 308-l can be scrambled with a P-RNTI unique to the subgroup 302-b and/or can otherwise indicate the subgroup 302-b. The DCI 308-l can indicate one or more time resources and/or frequency resources for the UEs within the subgroup 302-b to use to monitor for second DCI (e.g., DCI 308-m and DCI 308-n). The second DCI can be within POs allocated for paging messages to the subgroup 302-b, such as the PO #3 and the PO #4. Thus, the UEs within the subgroup 302-b can receive the DCI 308-l and can monitor for the DCI 308-m and the DCI 308-n. The UEs within the subgroup 302-b can receive the DCI 308-n and/or the DCI 308-m and can use scheduling information included in the DCI 308-n and/or the DCI 308-m to receive and decode one or more paging messages in the PO #3 and/or the PO #4.

The UEs in the subgroup 302-a may blind decode the DCI 308-l and may determine not to monitor for the DCI 308-n and the DCI 308-m based on the DCI 308-l being scrambled with a P-RNTI or otherwise identifying the subgroup 302-b. Additionally, or alternatively, the UEs in the subgroup 302-b may blind decode the DCI 308-i and may determine not to monitor for the DCI 308-j and the DCI 308-k based on the DCI 308-i being scrambled with a P-RNTI or otherwise identifying the subgroup 302-a. In some examples, the NE can transmit control signaling (e.g., RRC signaling, a MAC-CE, a SIB1, and/or other semi-static control signaling) to the UEs in the subgroup 302-a that indicates a monitoring occasion for the DCI 308-i, such that the UEs in the subgroup 302-a monitor for the DCI 308-i during the monitoring occasion and may not blind decode the DCI 308-l. Additionally, or alternatively, the NE can transmit control signaling (e.g., RRC signaling, a MAC-CE, a SIB1, and/or other semi-static control signaling) to the UEs in the subgroup 302-b that indicates a monitoring occasion for the DCI 308-l, such that the UEs in the subgroup 302-b monitor for the DCI 308-l during the monitoring occasion and may not blind decode the DCI 308-i.

Although the subgroup 302-a is illustrated as being configured with two POs (e.g., the PO #1 and the PO #2) that are FDMed, the subgroup 302-a can be configured with any numerical quantity of POs that can be FDMed and/or TDMed. Additionally, or alternatively, although the subgroup 302-b is illustrated as being configured with two POs (e.g., the PO #3 and the PO #4) that are FDMed, the subgroup 302-b can be configured with any numerical quantity of POs that can be FDMed and/or TDMed.

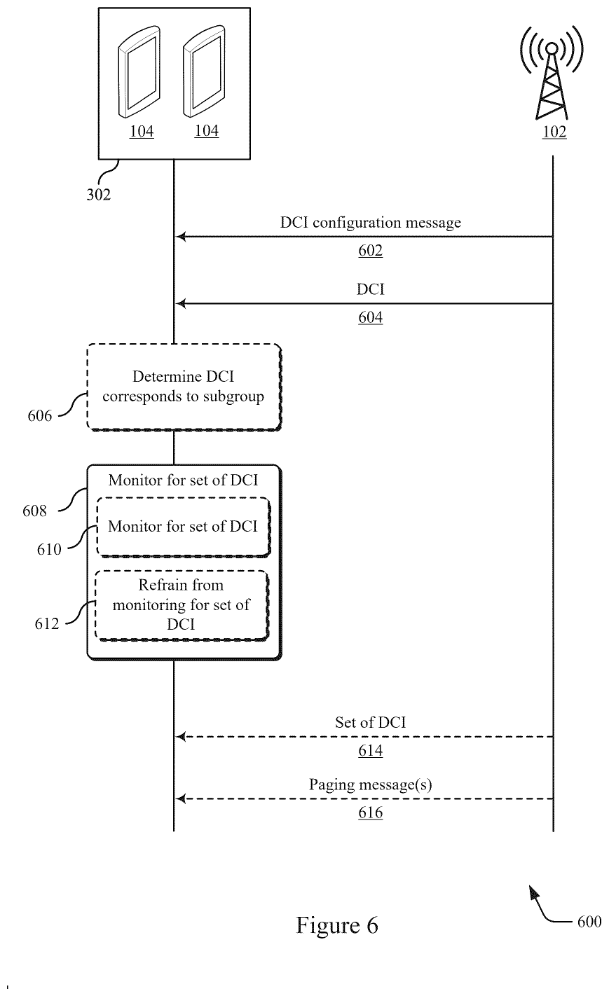

FIG. 6 illustrates an example of a signaling diagram 600 in accordance with aspects of the present disclosure. In some examples, the signaling diagram 600 may implement aspects of the wireless communications system 100, the transmission diagram 200, the wireless communications system 300, the wireless communications system 400, and the transmission diagram 500. The signaling diagram 600 may illustrate an example of a NE and a UE implementing a multi-stage DCI transmission scheme for paging. The UE 104 and the NE 102 can be examples of a UE 104 and a NE 102 as described with reference to FIGS. 1 through 6. Alternative examples of the following may be implemented, where some processes are performed in a different order than described or are not performed. In some cases, processes may include additional features not mentioned below, or further processes may be added.

In some cases, the NE 102 can communicate (e.g., transmit and/or receive messages) with one or more UEs 104 within a coverage area of the NE 102. The UEs 104 can be divided into subgroups, as described with reference to FIG. 5, where a subgroup 302 can include one or more UEs 104. Additionally, or alternatively, a UE 104 can include a low power radio and a main radio, as described with reference to FIG. 4.

At 602, one or more UEs 104 in the subgroup 302 can receive a DCI configuration message. The DCI configuration message can indicate DCI and a corresponding set of DCI, as well as a format for the DCI and the corresponding set of DCI. Each of the DCI and the set of DCI are associated with a paging message. For example, the DCI can indicate information for monitoring for the set of DCI, while the set of DCI indicate scheduling information and/or information for decoding the paging message.

At 604, the UEs 104 in the subgroup 302 can receive DCI. The DCI can include a first DCI message with one or more parameters. The UEs 104 can receive the DCI based on (e.g., using, via) one or more first time-frequency resources. The parameters can indicate a set of second time-frequency resources associated with the set of DCI (e.g., indicating a location in the time domain and frequency domain of the set of DCI). Additionally, or alternatively, the one or more parameters include a bitmap that indicates a resource in a frequency domain for at least one DCI in the set of DCI. The set of second time-frequency resources can include the resource. Additionally, or alternatively, the one or more parameters indicate one or more of an offset in a time domain between the first time-frequency resource and at least one time-frequency resource of the set of second time-frequency resources or at least one resource in a frequency domain corresponding to the respective POs. The DCI can be scrambled with a P-RNTI corresponding to the UEs 104 (e.g., the subgroup 302), such that if the UEs 104 in the subgroup 302 blind decode the DCI, then the UEs 104 can determine that the DCI is intended for the UEs 104 in the subgroup 302.

In some cases, at 606, the UEs 104 in the subgroup 302 can determine that the first DCI message corresponds to (e.g., is intended for) the subgroup 302. For example, the UEs 104 determine a subgroup of UEs based on different subgroups of UEs being assigned to different slots. The UEs 104 in the subgroup 302 can be assigned a slot that includes the respective POs. Additionally, or alternatively, the UEs 104 determine a subgroup of UEs based on the respective POs (e.g., or second set of time-frequency resources) being consecutive in the time domain and/or in a frequency domain.

At 608, the UEs 104 in the subgroup 302 can selectively monitor for a set of DCI based on the set of second time-frequency resources. The set of second time-frequency resources can include a set of downlink shared channel (e.g., PDSCH) resources. In some cases, at 610, the UEs 104 in the subgroup 302 can monitor for the set of DCI by monitoring the set of second time-frequency resources. For example, if the DCI at 604 is intended for the subgroup 302, then the UEs 104 can monitor for the set of DCI. In some other cases, at 612, the UEs 104 in the subgroup 302 can refrain from monitoring for the set of DCI. For example, if the DCI is not intended for the subgroup 302, then the UEs 104 can refrain from monitoring for the set of DCI.

In some cases, the DCI includes at least one parameter that indicates for the UEs 104 to monitor for the set of DCI or to refrain from monitoring (e.g., not monitor for) the set of DCI. Thus, the UEs 104 monitor for the DCI based on the value of the parameter. Additionally, or alternatively, the DCI includes at least one parameter that indicates the respective POs relative to a monitoring occasion during which the UE receives the DCI (e.g., the first time-frequency resource includes the monitoring occasion). In some examples, the DCI includes a bitmap with a set of codepoints that indicate respective subgroups of UEs for different sets of DCI. The UEs 104 monitor for the set of DCI if a codepoint in the bitmap indicates the subgroup 302. The UEs 104 refrain from monitoring for the set of DCI if a codepoint in the bitmap indicates a subgroup of UEs other than the subgroup 302. In some examples, the set of DCI includes scheduling information for respective downlink shared channels that include the paging message. Example scheduling information can include, but is not limited to, a short message indicator, a short message, an MCS, at least one resource in a frequency domain that includes the paging message, or at least one resource in a time domain that includes the paging message.

At 614, if the UEs 104 in the subgroup 302 monitor for the set of DCI, then the UEs 104 can receive the set of DCI. The set of DCI is at least one of FDMed or TDMed in respective POs that are allocated for a paging message. For example, the set of DCI is FDMed, and the set of second time-frequency resources includes a single resource in a time domain and respective resources in a frequency domain that include the set of DCI. In some examples, the respective resources in the frequency domain can be allocated using the respective POs that include the set of DCI, a starting RB index of a first (e.g., initial) DCI in the set of DCI, or a frequency domain offset of the set of DCI (e.g., an initial or first DCI in the set of DCI).

At 616, if the UEs 104 receive and decode the set of DCI, then the UEs 104 in the subgroup 302 can receive paging messages from the NE 102. The paging message can indicate for the UEs 104 to wake up from an inactive or idle mode to receive or transmit a data transmission. The DCI can additionally, or alternatively, include a WUS (e.g., a LP-WUS) for UEs 104 with a low power radio and a main radio, as described with reference to FIG. 4.

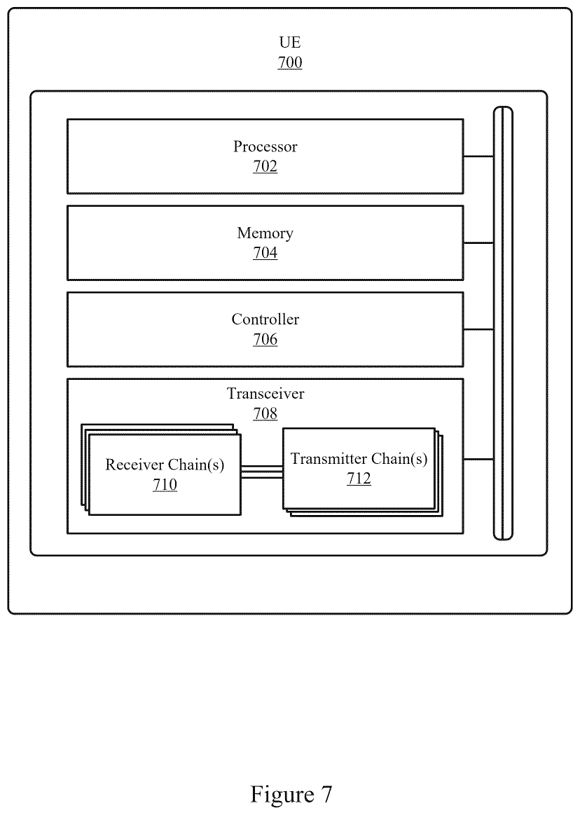

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions when executed by the processor 702 cause the UE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the functions described herein (e.g., executing, by the processor 702, instructions stored in the memory 704). For example, the processor 702 may support wireless communication at the UE 700 in accordance with examples as disclosed herein. The UE 700 may be configured to or operable to support a means for receiving a message for configuring a DCI and a set of DCI, where each of the DCI and the set of DCI are associated with a paging message, receiving, based on a first time-frequency resource, the DCI including one or more parameters that indicate a set of second time-frequency resources associated with the set of DCI, where the set of DCI is at least one of FDMed or TDMed in respective POs associated with the paging message, and monitoring for the set of DCI based on the set of second time-frequency resources.

Additionally, the DCI includes at least one parameter, and to monitor for the set of DCI, the UE 700 may be configured to support any one or combination of monitoring for the set of DCI based on the at least one parameter or refraining from monitoring for the set of DCI based on the at least one parameter. Additionally, or alternatively, the DCI includes at least one parameter that indicates the respective POs relative to a monitoring occasion associated with the DCI, and the first time-frequency resource includes the monitoring occasion. Additionally, or alternatively, the UE 700 may be configured to support determining a subgroup of UEs based on a slot including the respective POs. Additionally, or alternatively, the UE 700 may be configured to support determining a subgroup of UEs based on the respective POs being associated with at least one of consecutive time resources or consecutive frequency resources.

Additionally, or alternatively, the DCI includes a bitmap with a set of codepoints corresponding to the set of DCI, the set of codepoints indicating respective subgroups of UEs, and to monitor for the set of DCI, the UE 700 may be configured to support monitoring for the set of DCI based on a codepoint of the set of codepoints indicating a subgroup of UEs, or refraining from monitoring for the set of DCI based on a codepoint of the set of codepoints indicating a first subgroup of UEs different from a second subgroup of UEs. Additionally, or alternatively, the one or more parameters include a bitmap that indicates a resource in a frequency domain corresponding to at least one DCI of the set of DCI, and the set of second time-frequency resources includes the resource. Additionally, or alternatively, the one or more parameters indicate one or more of an offset in a time domain between the first time-frequency resource and at least one time-frequency resource of the set of second time-frequency resources or at least one resource in a frequency domain corresponding to the respective POs. Additionally, or alternatively, the set of second time-frequency resources includes a set of downlink shared channel resources. Additionally, or alternatively, the set of DCI includes scheduling information corresponding to respective downlink shared channels associated with the paging message, and the scheduling information includes a short message indicator, a short message, an MCS, at least one resource in a frequency domain corresponding to the paging message, or at least one resource in a time domain corresponding to the paging message.

Additionally, or alternatively, the DCI is scrambled with a P-RNTI corresponding to the UE. Additionally, or alternatively, the set of DCI is FDMed, and where the set of second time-frequency resources includes a single resource in a time domain and respective resources in a frequency domain corresponding to the set of DCI, the respective resources in the frequency domain based on one or more of the respective POs associated with the set of DCI, a starting RB index associated with the set of DCI, or a frequency domain offset corresponding to the set of DCI.

Additionally, or alternatively, the UE 700 may support at least one memory (e.g., the memory 704) and at least one processor (e.g., the processor 702) coupled with the at least one memory and configured to cause the UE to receive a message for configuring a DCI and a set of DCI, where each of the DCI and the set of DCI are associated with a paging message, receive, based on a first time-frequency resource, the DCI including one or more parameters that indicate a set of second time-frequency resources associated with the set of DCI, where the set of DCI is at least one of FDMed or TDMed in respective POs associated with the paging message, and monitor for the set of DCI based on the set of second time-frequency resources.

Additionally, or alternatively, the DCI includes at least one parameter, and to monitor for the set of DCI, the UE 700 may be configured to support the at least one processor is configured to monitor for the set of DCI based on the at least one parameter, or refrain from monitoring for the set of DCI based on the at least one parameter. Additionally, or alternatively, the DCI includes at least one parameter that indicates the respective POs relative to a monitoring occasion associated with the DCI, and the first time-frequency resource includes the monitoring occasion. Additionally, or alternatively, the UE 700 may be configured to support the at least one processor is configured to determine a subgroup of UEs based on a slot including the respective POs. Additionally, or alternatively, the UE 700 may be configured to support the at least one processor is configured to determine a subgroup of UEs based on the respective POs being associated with at least one of consecutive time resources or consecutive frequency resources.

Additionally, or alternatively, the DCI includes a bitmap with a set of codepoints corresponding to the set of DCI, the set of codepoints indicating respective subgroups of UEs, and to monitor for the set of DCI, the UE 700 may be configured to support the at least one processor is configured to monitor for the set of DCI based on a codepoint of the set of codepoints indicating a subgroup of UEs, or refrain from monitoring for the set of DCI based on a codepoint of the set of codepoints indicating a first subgroup of UEs different from a second subgroup of UEs. Additionally, or alternatively, the one or more parameters include a bitmap that indicates a resource in a frequency domain corresponding to at least one DCI of the set of DCI, and the set of second time-frequency resources includes the resource. Additionally, or alternatively, the one or more parameters indicate one or more of an offset in a time domain between the first time-frequency resource and at least one time-frequency resource of the set of second time-frequency resources or at least one resource in a frequency domain corresponding to the respective POs. Additionally, or alternatively, the set of second time-frequency resources includes a set of downlink shared channel resources. Additionally, or alternatively, the set of DCI includes scheduling information corresponding to respective downlink shared channels associated with the paging message, and the scheduling information includes a short message indicator, a short message, an MCS, at least one resource in a frequency domain corresponding to the paging message, or at least one resource in a time domain corresponding to the paging message.

Additionally, or alternatively, the DCI is scrambled with a P-RNTI corresponding to the UE. Additionally, or alternatively, the set of DCI is FDMed, and the set of second time-frequency resources includes a single resource in a time domain and respective resources in a frequency domain corresponding to the set of DCI, the respective resources in the frequency domain based on one or more of the respective POs associated with the set of DCI, a starting RB index associated with the set of DCI, or a frequency domain offset corresponding to the set of DCI.

The controller 706 may manage input and output signals for the UE 700. The controller 706 may also manage peripherals not integrated into the UE 700. In some implementations, the controller 706 may utilize an operating system such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

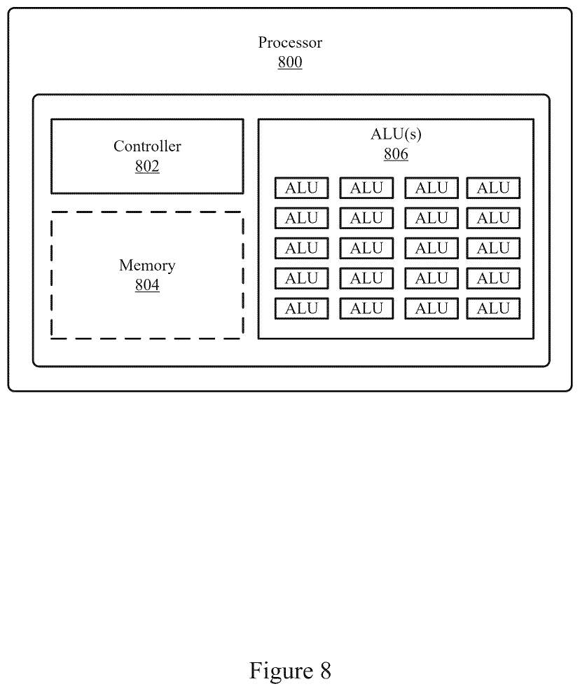

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

The processor 800 may support wireless communication in accordance with examples as disclosed herein. The processor 800 may be configured to or operable to support at least one controller (e.g., the controller 802) coupled with at least one memory (e.g., the memory 804) and configured to cause the processor to receive a message for configuring a DCI and a set of DCI, where each of the DCI and the set of DCI are associated with a paging message, receive, based on a first time-frequency resource, the DCI including one or more parameters that indicate a set of second time-frequency resources associated with the set of DCI, where the set of DCI is at least one of FDMed or TDMed in respective POs associated with the paging message, and monitor for the set of DCI based on the set of second time-frequency resources.

Additionally, the processor 800 may be configured to or operable to support any one or combination of the DCI includes at least one parameter, and to monitor for the set of DCI, the at least one controller is configured to cause the processor to monitor for the set of DCI based on the at least one parameter, or refrain from monitoring for the set of DCI based on the at least one parameter. Additionally, or alternatively, the DCI includes at least one parameter that indicates the respective POs relative to a monitoring occasion associated with the DCI, and the first time-frequency resource includes the monitoring occasion. Additionally, or alternatively, the at least one controller is configured to cause the processor to determine a subgroup of UEs based on a slot including the respective POs. Additionally, or alternatively, the at least one controller is configured to cause the processor to determine a subgroup of UEs based on the respective POs being associated with at least one of consecutive time resources or consecutive frequency resources.

Additionally, or alternatively, the DCI includes a bitmap with a set of codepoints corresponding to the set of DCI, the set of codepoints indicating respective subgroups of UEs, and to monitor for the set of DCI, the at least one controller is configured to cause the processor to monitor for the set of DCI based on a codepoint of the set of codepoints indicating a subgroup of UEs, or refrain from monitoring for the set of DCI based on a codepoint of the set of codepoints indicating a first subgroup of UEs different from a second subgroup of UEs. Additionally, or alternatively, the one or more parameters include a bitmap that indicates a resource in a frequency domain corresponding to at least one DCI of the set of DCI, and the set of second time-frequency resources includes the resource. Additionally, or alternatively, the one or more parameters indicate one or more of an offset in a time domain between the first time-frequency resource and at least one time-frequency resource of the set of second time-frequency resources or at least one resource in a frequency domain corresponding to the respective POs. Additionally, or alternatively, the set of second time-frequency resources includes a set of downlink shared channel resources. Additionally, or alternatively, the set of DCI includes scheduling information corresponding to respective downlink shared channels associated with the paging message, and the scheduling information includes a short message indicator, a short message, an MCS, at least one resource in a frequency domain corresponding to the paging message, or at least one resource in a time domain corresponding to the paging message.

Additionally, or alternatively, the DCI is scrambled with a P-RNTI corresponding to the UE. Additionally, or alternatively, the set of DCI is FDMed, and the set of second time-frequency resources includes a single resource in a time domain and respective resources in a frequency domain corresponding to the set of DCI, the respective resources in the frequency domain based on one or more of the respective POs associated with the set of DCI, a starting RB index associated with the set of DCI, or a frequency domain offset corresponding to the set of DCI.

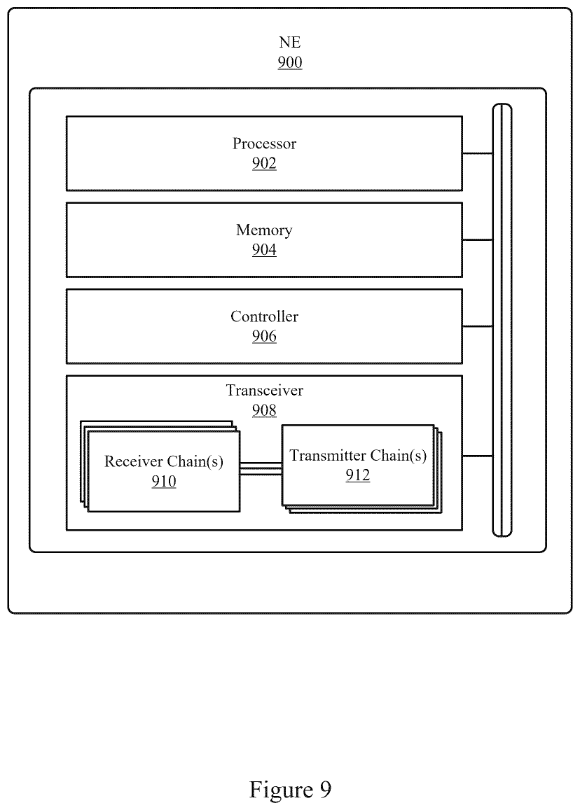

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such as the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the functions described herein (e.g., executing, by the processor 902, instructions stored in the memory 904). For example, the processor 902 may support wireless communication at the NE 900 in accordance with examples as disclosed herein. The NE 900 may be configured to or operable to support a means for transmitting a message for configuring a DCI and a set of DCI, where each of the DCI and the set of DCI are associated with a paging message, transmitting, based on a first time-frequency resource, the DCI including one or more parameters that indicate a set of second time-frequency resources associated with the set of DCI, where the set of DCI is at least one of FDMed or TDMed in respective POs associated with the paging message, and transmitting the set of DCI based on the set of second time-frequency resources.

Additionally, the NE 900 may be configured to or operable to support any one or combination of the method further comprising the DCI includes at least one parameter that indicates for a UE to monitor for the set of DCI or to refrain from monitoring for the set of DCI. Additionally, or alternatively, the NE 900 may be configured to or operable to support the DCI includes at least one parameter that indicates the respective POs relative to a monitoring occasion associated with the DCI, and the first time-frequency resource includes the monitoring occasion. Additionally, or alternatively, the NE 900 may be configured to or operable to support a subgroup of UEs associated with the paging message is based on a slot including the respective POs. Additionally, or alternatively, the NE 900 may be configured to or operable to support a subgroup of UEs associated with the paging message is based on the respective POs being associated with at least one of consecutive time resources or consecutive frequency resources. Additionally, or alternatively, the NE 900 may be configured to or operable to support the DCI includes a bitmap with a set of codepoints corresponding to the set of DCI, the set of codepoints indicating respective subgroups of UEs.

Additionally, or alternatively, the NE 900 may be configured to or operable to support the one or more parameters include a bitmap that indicates a resource in a frequency domain corresponding to at least one DCI of the set of DCI, and the set of second time-frequency resources includes the resource. Additionally, or alternatively, the NE 900 may be configured to or operable to support the one or more parameters indicate one or more of an offset in a time domain between the first time-frequency resource and at least one time-frequency resource of the set of second time-frequency resources or at least one resource in a frequency domain corresponding to the respective POs. Additionally, or alternatively, the NE 900 may be configured to or operable to support the set of second time-frequency resources includes a set of downlink shared channel resources. Additionally, or alternatively, the NE 900 may be configured to or operable to support the set of DCI includes scheduling information corresponding to respective downlink shared channels associated with the paging message, and the scheduling information includes a short message indicator, a short message, an MCS, at least one resource in a frequency domain corresponding to the paging message, or at least one resource in a time domain corresponding to the paging message.

Additionally, or alternatively, the NE 900 may be configured to or operable to support the DCI is scrambled with a P-RNTI corresponding to one or more UE. Additionally, or alternatively, the set of DCI is FDMed, and the set of second time-frequency resources includes a single resource in a time domain and respective resources in a frequency domain corresponding to the set of DCI, the respective resources in the frequency domain based on one or more of the respective POs associated with the set of DCI, a starting RB index associated with the set of DCI, or a frequency domain offset corresponding to the set of DCI.

Additionally, or alternatively, the NE 900 may support at least one memory (e.g., the memory 904) and at least one processor (e.g., the processor 902) coupled with the at least one memory and configured to cause the NE to transmit a message for configuring a DCI and a set of DCI, where each of the DCI and the set of DCI are associated with a paging message, transmit, based on a first time-frequency resource, the DCI including one or more parameters that indicate a set of second time-frequency resources associated with the set of DCI, where the set of DCI is at least one of FDMed or TDMed in respective POs associated with the paging message, and transmit the set of DCI based on the set of second time-frequency resources.

Additionally, the NE 900 may be configured to support any one or combination of the DCI includes at least one parameter that indicates for a UE to monitor for the set of DCI or to refrain from monitoring for the set of DCI. Additionally, or alternatively, the NE 900 may be configured to support the DCI includes at least one parameter that indicates the respective POs relative to a monitoring occasion associated with the DCI, and where the first time-frequency resource includes the monitoring occasion. Additionally, or alternatively, the NE 900 may be configured to support a subgroup of UEs associated with the paging message is based on a slot including the respective POs. Additionally, or alternatively, the NE 900 may be configured to support a subgroup of UEs associated with the paging message is based on the respective POs being associated with at least one of consecutive time resources or consecutive frequency resources. Additionally, or alternatively, the NE 900 may be configured to support the DCI includes a bitmap with a set of codepoints corresponding to the set of DCI, the set of codepoints indicating respective subgroups of UEs.

Additionally, or alternatively, the NE 900 may be configured to support the one or more parameters include a bitmap that indicates a resource in a frequency domain corresponding to at least one DCI of the set of DCI, and the set of second time-frequency resources includes the resource. Additionally, or alternatively, the NE 900 may be configured to support the one or more parameters indicate one or more of an offset in a time domain between the first time-frequency resource and at least one time-frequency resource of the set of second time-frequency resources or at least one resource in a frequency domain corresponding to the respective POs. Additionally, or alternatively, the NE 900 may be configured to support the set of second time-frequency resources includes a set of downlink shared channel resources. Additionally, or alternatively, the NE 900 may be configured to support the set of DCI includes scheduling information corresponding to respective downlink shared channels associated with the paging message, and the scheduling information includes a short message indicator, a short message, an MCS, at least one resource in a frequency domain corresponding to the paging message, or at least one resource in a time domain corresponding to the paging message.

Additionally, or alternatively, the NE 900 may be configured to support the DCI is scrambled with a P-RNTI corresponding to one or more UE. Additionally, or alternatively, the NE 900 may be configured to support the set of DCI is FDMed, and where the set of second time- frequency resources includes a single resource in a time domain and respective resources in a frequency domain corresponding to the set of DCI, the respective resources in the frequency domain based on one or more of the respective POs associated with the set of DCI, a starting RB index associated with the set of DCI, or a frequency domain offset corresponding to the set of DCI.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas to receive a signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

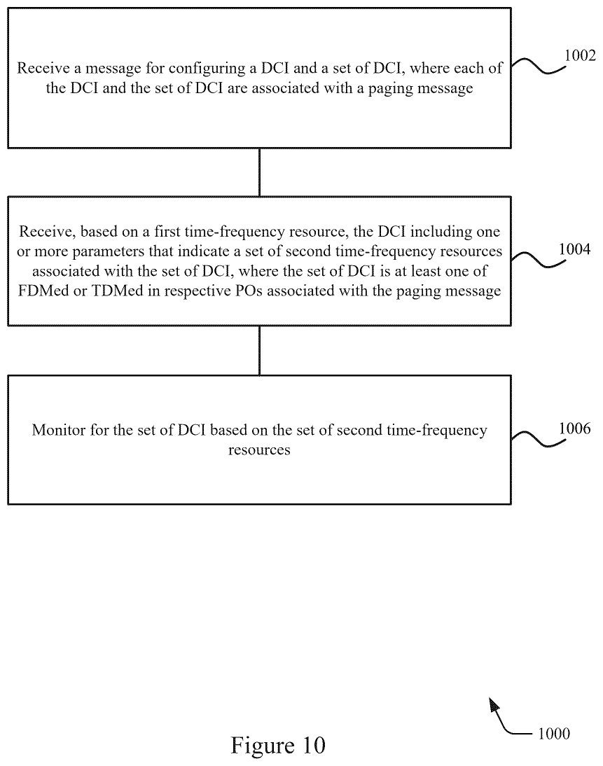

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 1002, the method may include receiving a message for configuring a DCI and a set of DCI, where each of the DCI and the set of DCI are associated with a paging message. The operations of 1002 may be performed in accordance with examples as described herein. In some implementations, aspects of the operations of 1002 may be performed by a UE as described with reference to FIG. 7.

At 1004, the method may include receiving, based on a first time-frequency resource, the DCI including one or more parameters that indicate a set of second time-frequency resources associated with the set of DCI, where the set of DCI is at least one of FDMed or TDMed in respective POs associated with the paging message. The operations of 1004 may be performed in accordance with examples as described herein. In some implementations, aspects of the operations of 1004 may be performed by a UE as described with reference to FIG. 7.

At 1006, the method may include monitoring for the set of DCI based on the set of second time-frequency resources. The operations of 1006 may be performed in accordance with examples as described herein. In some implementations, aspects of the operations of 1006 may be performed a UE as described with reference to FIG. 7.

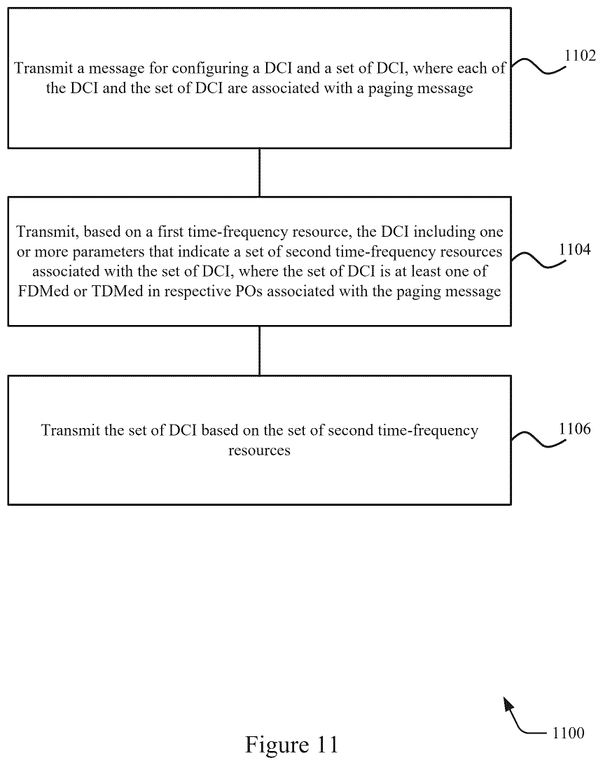

FIG. 11 illustrates a flowchart of a method 1100 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1102, the method may include transmitting a message for configuring a DCI and a set of DCI, where each of the DCI and the set of DCI are associated with a paging message. The operations of 1102 may be performed in accordance with examples as described herein. In some implementations, aspects of the operations of 1102 may be performed by a NE as described with reference to FIG. 9.

At 1104, the method may include transmitting, based on a first time-frequency resource, the DCI including one or more parameters that indicate a set of second time-frequency resources associated with the set of DCI, where the set of DCI is at least one of FDMed or TDMed in respective POs associated with the paging message. The operations of 1104 may be performed in accordance with examples as described herein. In some implementations, aspects of the operations of 1104 may be performed by a NE as described with reference to FIG. 9.

At 1106, the method may include transmitting the set of DCI based on the set of second time-frequency resources. The operations of 1106 may be performed in accordance with examples as described herein. In some implementations, aspects of the operations of 1106 may be performed a NE as described with reference to FIG. 9.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a message for configuring a downlink control information (DCI) and a plurality of DCI, wherein each of the DCI and the plurality of DCI are associated with a paging message;
receive, based at least in part on a first time-frequency resource, the DCI comprising one or more parameters that indicate a plurality of second time-frequency resources associated with the plurality of DCI, wherein the plurality of DCI is at least one of frequency division multiplexed or time division multiplexed in respective paging occasions associated with the paging message; and
monitor for the plurality of DCI based at least in part on the plurality of second time-frequency resources.

2. The UE of claim 1, wherein the DCI comprises at least one parameter, and wherein to monitor for the plurality of DCI, the at least one processor is configured to cause the UE to:
monitor for the plurality of DCI based at least in part on the at least one parameter; or
refrain from monitoring for the plurality of DCI based at least in part on the at least one parameter.

3. The UE of claim 1, wherein the DCI comprises at least one parameter that indicates the respective paging occasions relative to a monitoring occasion associated with the DCI, and wherein the first time-frequency resource comprises the monitoring occasion.

4. The UE of claim 1, wherein the at least one processor is further configured to cause the UE to determine a subgroup of UEs based at least in part on a slot comprising the respective paging occasions.

5. The UE of claim 1, wherein the at least one processor is further configured to cause the UE to determine a subgroup of UEs based at least in part on the respective paging occasions being associated with at least one of consecutive time resources or consecutive frequency resources.

6. The UE of claim 1, wherein the DCI comprises a bitmap with a plurality of codepoints corresponding to the plurality of DCI, the plurality of codepoints indicating respective subgroups of UEs, and wherein to monitor for the plurality of DCI, the at least one processor is configured to cause the UE to:
monitor for the plurality of DCI based at least in part on a codepoint of the plurality of codepoints indicating a subgroup of UEs; or
refrain from monitoring for the plurality of DCI based at least in part on a codepoint of the plurality of codepoints indicating a first subgroup of UEs different from a second subgroup of UEs.

7. The UE of claim 1, wherein the one or more parameters comprise a bitmap that indicates a resource in a frequency domain corresponding to at least one DCI of the plurality of DCI, and wherein the plurality of second time-frequency resources comprises the resource.

8. The UE of claim 1, wherein the one or more parameters indicate one or more of an offset in a time domain between the first time-frequency resource and at least one time-frequency resource of the plurality of second time-frequency resources or at least one resource in a frequency domain corresponding to the respective paging occasions.

9. The UE of claim 1, wherein the plurality of second time-frequency resources comprises a plurality of downlink shared channel resources.

10. The UE of claim 1, wherein the plurality of DCI comprises scheduling information corresponding to respective downlink shared channels associated with the paging message, and wherein the scheduling information comprises a short message indicator, a short message, a modulation and coding scheme (MCS), at least one resource in a frequency domain corresponding to the paging message, or at least one resource in a time domain corresponding to the paging message.

11. The UE of claim 1, wherein the DCI is scrambled with a paging-radio network temporary identifier (P-RNTI) corresponding to the UE.

12. The UE of claim 1, wherein the plurality of DCI is frequency division multiplexed, and wherein the plurality of second time-frequency resources comprises a single resource in a time domain and respective resources in a frequency domain corresponding to the plurality of DCI, the respective resources in the frequency domain based at least in part on one or more of the respective paging occasions associated with the plurality of DCI, a starting resource block index associated with the plurality of DCI, or a frequency domain offset corresponding to the plurality of DCI.

13. A processor for wireless communication, comprising:
at least one controller coupled with at least one memory and configured to cause the processor to:
receive a message for configuring a downlink control information (DCI) and a plurality of DCI, wherein each of the DCI and the plurality of DCI are associated with a paging message;
receive, based at least in part on a first time-frequency resource, the DCI comprising one or more parameters that indicate a plurality of second time-frequency resources associated with the plurality of DCI, wherein the plurality of DCI is at least one of frequency division multiplexed or time division multiplexed in respective paging occasions associated with the paging message; and
monitor for the plurality of DCI based at least in part on the plurality of second time-frequency resources.

14. A method performed by a user equipment (UE), the method comprising:
receiving a message for configuring a downlink control information (DCI) and a plurality of DCI, wherein each of the DCI and the plurality of DCI are associated with a paging message;
receiving, based at least in part on a first time-frequency resource, the DCI comprising one or more parameters that indicate a plurality of second time-frequency resources associated with the plurality of DCI, wherein the plurality of DCI is at least one of frequency division multiplexed or time division multiplexed in respective paging occasions associated with the paging message; and
monitoring for the plurality of DCI based at least in part on the plurality of second time-frequency resources.

15. A base station for wireless communication, comprising:
at least one memory; and
at least one processor coupled with the at least one memory and configured to cause the base station to:
transmit a message for configuring a downlink control information (DCI) and a plurality of DCI, wherein each of the DCI and the plurality of DCI are associated with a paging message;
transmit, based at least in part on a first time-frequency resource, the DCI comprising one or more parameters that indicate a plurality of second time-frequency resources associated with the plurality of DCI, wherein the plurality of DCI is at least one of frequency division multiplexed or time division multiplexed in respective paging occasions associated with the paging message; and
transmit the plurality of DCI based at least in part on the plurality of second time-frequency resources.

16. The base station of claim 15, wherein the DCI comprises at least one parameter that indicates for a UE to monitor for the plurality of DCI or to refrain from monitoring for the plurality of DCI.

17. The base station of claim 15, wherein the DCI comprises at least one parameter that indicates the respective paging occasions relative to a monitoring occasion associated with the DCI, and wherein the first time-frequency resource comprises the monitoring occasion.

18. The base station of claim 15, wherein a subgroup of UEs associated with the paging message is based at least in part on a slot comprising the respective paging occasions.

19. The base station of claim 15, wherein a subgroup of UEs associated with the paging message is based at least in part on the respective paging occasions being associated with at least one of consecutive time resources or consecutive frequency resources.

20. The base station of claim 15, wherein the DCI comprises a bitmap with a plurality of codepoints corresponding to the plurality of DCI, the plurality of codepoints indicating respective subgroups of UEs.
